(19) United States
(12) Patent Application Publication
(10) Pub. No.: US 2014/0082129 A1
(43) Pub. Date: Mar. 20, 2014

(54) SYSTEM AND METHOD FOR MANAGING A SYSTEM OF APPLIANCES THAT ARE ATTACHED TO A NETWORKED FILE SYSTEM

(71) Applicant: NetApp, Inc., Sunnyvale, CA (US)

(72) Inventors: Derek Beard, Austin, TX (US); Pearce Barry, Cedar Park, TX (US); Kris Meier, Cedar Park, TX (US)

(73) Assignee: NetApp, Inc., Sunnyvale, CA (US)

(21) Appl. No.: 14/031,019

(22) Filed: Sep. 18, 2013

Related U.S. Application Data
(60) Provisional application No. 61/702,690, filed on Sep. 18, 2012.

(51) Int. Cl. H04L 29/08

(52) U.S. Cl. CPC H04L 29/08801; H04L 29/08549
USPC 709/216

(57) ABSTRACT

A caching system to monitor and respond to system health events/changes at the caching system.

### RELATED APPLICATIONS

This patent application claims benefit of priority to Provisional U.S. Patent Application No. 61/702,690; the aforementioned priority application being hereby incorporated by reference in its entirety for all purposes.

### TECHNICAL FIELD

Examples described herein relate to managing a system of appliances that are attached to a networked file system.

### BACKGROUND

Data storage technology over the years has evolved from a direct attached storage model (DAS) to using remote computer storage models, such as Network Attached Storage (NAS) and a Storage Area Network (SAN). With the direct storage model, the storage is directly attached to the workstations and application servers, but this creates numerous difficulties with the administration, backup, compliance and maintenance of the directly stored data. These difficulties are alleviated at least in part by separating the application server/workstations from the storage medium. For example, FIG. 1 depicts a typical NAS system 100 in which a number of PCs, workstations and application servers (clients) use a network 10 to access storage resources on a number of remote network attached storage and file servers (or filers). In the depicted system 100, each of the networked PC or workstation devices 12-14 and application servers 16-18 may act as a storage client that is connected to the network 10 by the appropriate routers 11 and switches 15 to remotely store and retrieve data with one or more NAS filers 1-6, which in turn are connected to the network 10 by the appropriate routers 9 and switches 7-8. Typically, the storage clients (e.g., 14) use an IP-based network protocol, such as CIFS and NFS, to communicate store, retrieve and modify files on an NAS filer (e.g., 5).

Conventional NAS devices are designed with data storage hardware components (including a plurality of hard disk drives, one or more processors for controlling access to the disk drives, I/O controller and high speed cache memory) and operating system and other software that provides data storage and access functions. Even with a high speed internal cache memory, the access response time for NAS devices continues to be outpaced by the faster processor speeds in the client devices 12-14, 16-18, especially where anyone NAS device may be connected to a plurality of clients. In part, this performance problem is caused by the lower cache hit rates that result from a combination of larger and constantly changing active data sets and large number of clients mounting the NAS storage device.

### BRIEF DESCRIPTION OF THE DRAWINGS

FIG. 1 depicts a prior art NAS system.

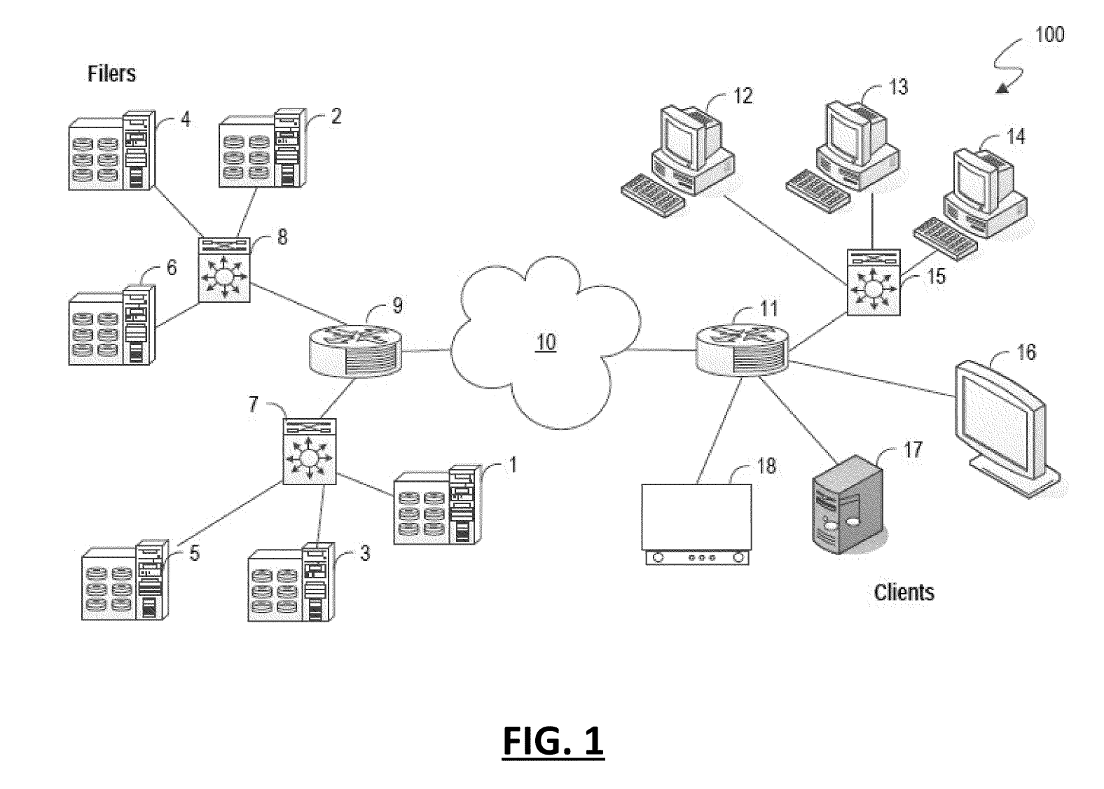

FIG. 2 illustrates an example of a networked system that utilizes intelligent, cache appliances, including topology detection logic, according to an embodiment.

FIG. 3 illustrates an example of a cache system for use with a system such as described with FIG. 2.

FIG. 4 illustrates another example of a cache system for use with a system such as described with FIG. 2.

FIG. 5 illustrates another example of a cache system for use with a system such as described with FIG. 2.

FIG. 6 illustrates another example of a cache system for use with a system such as described with FIG. 2.

FIG. 7 illustrates a NAS cache system deployed on a networked system, according to one or more details.

FIG. 8 illustrates an example of the functional operation of a NAS data server appliance 801 connected between redundant flow director appliances.

FIG. 9 illustrates an example process flow sequence for a dynamic configuration process between the flow director and data server appliances over interconnect system bus.

FIG. 10 depicts an example process flow sequence for a heartbeat-and-failover state machine, according to one or more embodiments.

FIG. 11 which depicts an example process flow sequence for a heartbeat-and-failover state machine, according to embodiments.

### DETAILED DESCRIPTION

Examples described herein include a caching system to monitor and respond to system health events/changes at the caching system.

Among other benefits, a high-performance network attached storage (NAS) caching appliance can be provided for a networked file system to deliver enhanced performance to I/O intensive applications, while relieving overburdened storage subsystems. The examples described herein identify the active data sets of the networked system and use predetermined policies to control what data gets cached using a combination of DRAM and SSDs to improve performance, including guaranteeing the best performance for the most important applications. Examples described herein can further be positioned between the storage clients and the NAS filers, to intercept requests between the clients and filers, and to provide read and write cache acceleration by storing and recalling frequently used information. In some embodiments, the NAS caching system includes one or more flow director appliances and data server appliances connected over an interconnect system bus. The NAS caching system uses the interconnect system bus to address the data server appliance(s) and flow director appliance(s), and to monitor and respond to system health events/changes at the NAS caching system, such as failures at a flow director appliance, data server appliance, and/or interconnect bus.

Examples described herein provide for a high-performance network attached storage (NAS) caching appliance and system. In an embodiment, a NAS cache appliances manages the interconnect busses connecting one or more flow directors and data server appliances, in order to monitor and respond to system health events/changes. In some embodiments, each of the NAS cache appliances includes an interconnect bus manager that provides address configuration and monitoring functions for each NAS cache appliance. In addition, a computer program product is disclosed that includes a non-transitory computer readable storage medium having computer readable program code embodied therein with instructions which are adapted to be executed to implement a method for operating a NAS caching appliance, substantially as described hereinabove. In selected embodiments, the operations described herein may be implemented using, among other components, one or more processors that run one or more software programs or modules embodied in circuitry and/or non-transitory storage media device(s) (e.g., RAM, ROM, flash memory, etc.) to communicate to receive and/or send data and messages. Thus, it will be appreciated by one skilled in the art that the present invention may be embodied in whole or in part as a method, system, or computer program product. For example, a computer-usable medium embodying computer program code may be used, where the computer program code comprises computer executable instructions configured to use the interconnect bus to monitor appliance failures using gratuitous ARP or heartbeat messages and respond to any failures at the interconnect bus or other system appliance. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

In selected embodiments, the operations described herein may be implemented using, among other components, one or more processors that run one or more software programs or modules embodied in circuitry and/or non-transitory storage media device(s) (e.g., RAM, ROM, flash memory, etc.) to communicate to receive and/or send data and messages. Thus, it will be appreciated by one skilled in the art that the present invention may be embodied in whole or in part as a method, system, or computer program product. For example, a computer-usable medium embodying computer program code may be used, where the computer program code comprises computer executable instructions configured to provide dynamically detect and select file servers associated with a requested caching operation. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

It should be understood that as used herein, terms such as coupled, connected, electrically connected, in signal communication, and the like may include direct connections between components, indirect connections between components, or both, as would be apparent in the overall context of a particular embodiment. The term coupled is intended to include, but not be limited to, a direct electrical connection.

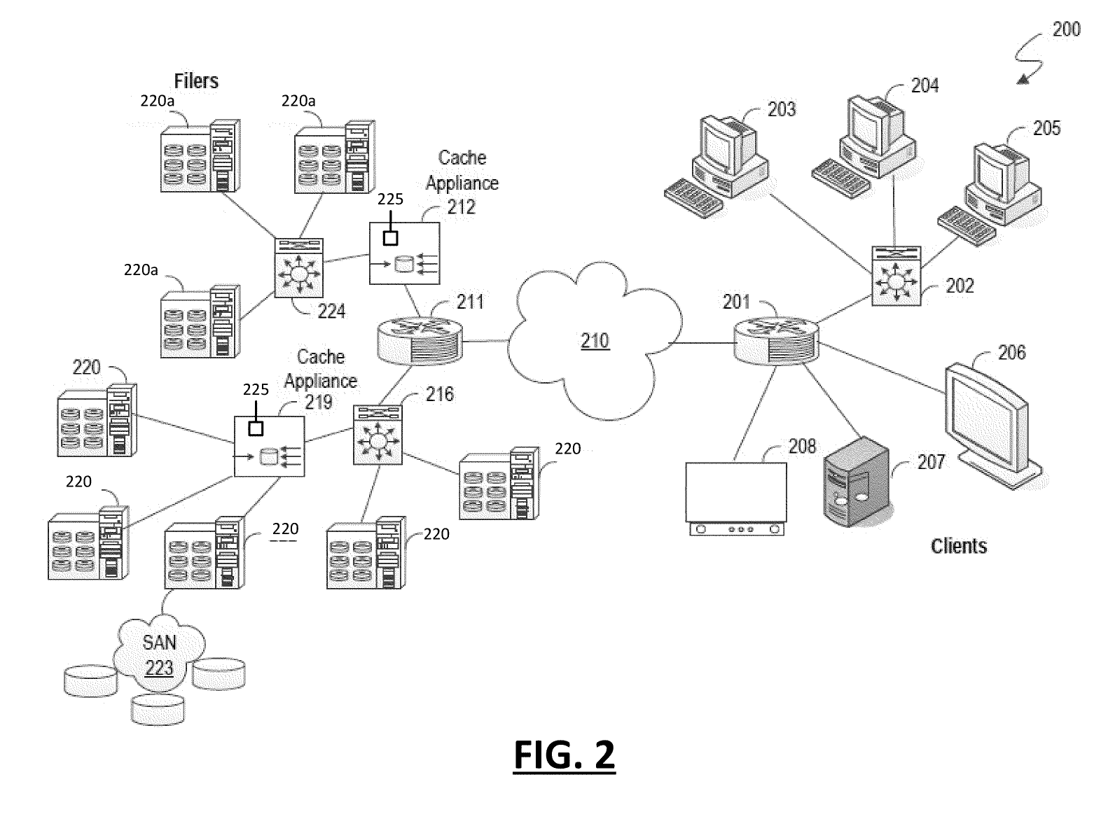

FIG. 2 illustrates an example of a networked system that utilizes intelligent, cache appliances, including monitors to ensure consistent handling of traffic being passed through the networked system, according to an embodiment. In an example of FIG. 2, an enterprise network system 200 includes multiple file system servers 220 and file system server groups 220a that collectively operate as one or more NAS filers of the enterprise file system 200. The system 200 includes one or more cache appliances 212, 219 located in front of a file system server 220 and/or file system server groups 220a. One or more clients 203-205 or 206-208 connect to and utilize the enterprise file system 200. In the example provided, clients 203-205 correspond to, for example, mobile or desktop PCs or workstations, and clients 206-208 correspond to application servers (collectively termed “clients 203-208”). Each of the clients 203-208 may run a separate application which requires access to remotely-stored application data. In operation, a requesting client sends a read or write request over the network 210 using the appropriate routers 201, 211 and/or switches 202, 216, 224. Such requests may be directed to the destination NAS filer using an appropriate IP-based network protocol, such as, for example, CIFS or NFS.

According to examples described herein, the cache appliances 212, 219 are disposed logically and/or physically between at least some clients 203-208 and the file system server 220 and/or filer server groups 220a of the NAS filer. In more detail the cache appliances 212, 219 include intelligent cache appliances which are installed in-line between individual clients 203-208 and the destination NAS filer. The individual clients 203-208 issue requests for a respective NAS filer provided with the system 200. Such requests can include read or write requests in which file system objects of the respective NAS filer is used. More specifically, examples described herein provide for the cache appliances 212, 219 to (i) store a segment of the data of the NAS filer, and (ii) process requests from the clients 203-208 directed to the NAS filer. The cache appliances 212, 219 can each include programmatic resources to optimize the handling of requests from the clients 203-208 in a manner that is transparent to the clients 203-208. In particular, the cache appliances 212, 219 can respond to individual client requests, including (i) returning up-to-date but cached application data from file system objects identified from the client requests, and/or (ii) queuing and then forwarding, onto the NAS filer, write, modify or create operations (which affect the NAS filer), and subsequently updating the contents of the respective cache appliances 212, 219. In general, the cache appliances 212, 219 enable the individual client requests to be processed more quickly than would otherwise occur if the client requests were processed from the disk arrays or internal cache memory of the file system servers. More generally, the cache appliances 212, 219 can be positioned in-line to cache the NAS filer without requiring the clients 203-208 to unmount from the NAS filer.

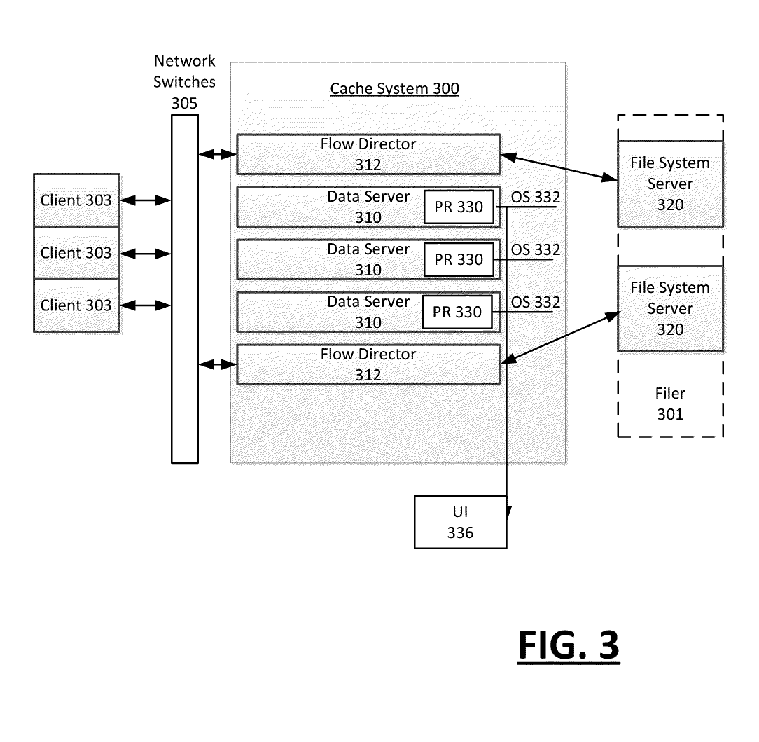

In an example of FIG. 2, each cache appliance 212, 219 can include one or more cache appliances that are connected together and working in tandem to form a single homogeneous caching device. Examples of cache appliances 212, 219 are provided with embodiments described with FIG. 3 through FIG. 6, as well as elsewhere in this application. Furthermore, in an example of FIG. 2, each cache appliance 212, 219 can include an appliance that is constructed as a high-speed packet processor with a substantial cache memory. For example, each cache appliance 212, 219 can correspond to an appliance that includes a set of network processing resources (such as a network switch and network processor(s)), a dynamic cache memory, a non-volatile cache memory and/or cache controller(s). The processing resources of the individual cache appliances 212, 219 can be configured to handle, for example, NFS type requests from the clients 203-208.

As further shown by an example of FIG. 2, individual cache appliances 212, 219, can be installed in multiple different locations of the system 200. In this manner, the individual cache appliances 212, 219 provide caching resources for one or more NAS filers, as shown by the placement of the cache appliance 219 in relation to file servers 220, or alternatively, to a group of NAS filers as shown by the placement of the cache appliance 212 in relation to the NAS filers provided by the file servers 220 and file server groups 220a. However positioned, the cache appliances 212, 219 each operate to intercept requests between the clients and the servers 220. In this way, the cache appliances 212, 219 are able to provide read and write cache acceleration by storing and recalling frequently used information. In some embodiments, the cache appliances 212, 219 are positioned as part of a required path between a respective file server and some or all of the clients. In particular, the cache appliances 212, 219 are positioned to intercept traffic directed from clients 203-208 to a particular file server 220 or set of file servers 220a in order to avoid cache coherency problems. In particular, cache coherency problems can arise when a piece of information stored with cache appliance 212, 219 is modified through an alternate path.

As described with some examples, each cache appliance 212, 219 can be provided with packet inspection functionality. In this way, each cache appliance 212, 219 are able to inspect the information of each of the intercepted packets in each of the TCP/IP stack layers. Through packet inspection, cache appliances 212, 219 can determine (i) the physical port information for the sender and receiver from the Layer 2 (data link layer), (ii) the logical port information for the sender and receiver from the Layer 3 (network layer), (iii) the TCP/UDP protocol connection information from the Layer 4 (transport layer), and (iv) the NSF/CIFS storage protocol information from the Layer 5 (session layer). Additionally, some embodiments provide that the cache appliances 212, 219 can perform packet inspection to parse and extract the fields from the upper layers (e.g., Layer 5-Layer 7). Still further, some embodiments provide that the packet inspection capability enables each cache appliance 212, 219 to be spliced seamlessly into the network so that it is transparent to the Layer 3 and Layer 4 layers.

According to embodiments, the cache appliances 212, 219 can accelerate responses to storage requests made from the clients. In particular, the packet inspection capability enables each cache appliance 212, 219 to be spliced seamlessly into the network so that it is transparent to the Layer 3 and Layer 4 layers and only impacts the storage requests by processing them for the purposes of accelerating them, i.e., as a bump-in-the-wire. Rather than splicing all of the connection parameters in the Layer 2, Layer 3 and Layer 4, some embodiments provide that each cache appliance 212, 219 can splice only the connection state, source sequence number and destination sequence number in Layer 4. By leaving unchanged the source and destination MAC addresses in the Layer 2, the source and destination IP addresses in the Layer 3 and the source and destination port numbers in the Layer 4, the cache appliances 212, 219 can generate a programmatic perception that a given client 203-208 is communicating with one of the NAS filers of the enterprise network system 200. As such, there is no awareness at either the clients 203-208 or file servers 220, 220a of any intervening cache appliance 212, 219. In this way, the cache appliances 212, 219 can be inserted seamlessly into an existing connection with the clients 203, 208 and the NAS filer(s) provided with the system 200, without requiring the clients to be unmounted. Additionally, among other benefits, the use of spliced connections in connecting the cache appliances 212, 219 to the file servers 220 and file server groups 220 enable much, if not all, of the data needs of the individual clients to be served from the cache, while providing periodic updates to meet the connection timeout protocol requirements of the file servers 220.

In more detail, the cache appliance 212, 219 can process a read or write request by making only Layer 1 and Layer 2 configuration changes during installation or deployment. As a result, no filer or client configuration changes are required in order to take advantage of the cache appliance. With this capability, an installed cache appliance 212, 219 (e.g., appliance) provides a relatively fast and transparent storage caching solution which allows the same connections to be maintained between clients and filers. As described with some embodiments, if there is a failure at the cache appliance 212, 219, the cache appliance automatically becomes a wire (e.g., pass through) between the client and filer who are able to communication directly without any reconfiguration.

According to some embodiments, cache appliance 212, 219 are implemented as a network attached storage (NAS) cache appliance, and connected as an in-line appliance or software that is positioned in the enterprise network system 200 to intercept requests to one or more of the file servers 220, or server groups 220a. This configuration provides clients 203-208 expedited access to the data within the requested files, so as to accelerate NAS storage performance. As an appliance, cache appliances 212, 219 can provide acceleration performance by storing the data of the NAS filers (provided from the file servers 220 and server groups 220a) in high-speed media. In some embodiments, cache appliances 212, 219 are transparently installed appliances, deployed between the clients 203-208 and file system servers 220, 220a without any network or reconfiguration of the endpoints. Without client or file server configuration changes, the cache appliances 212, 219 can operate intelligently to find the active dataset (or a designated dataset) of the NAS filers, and further to copy the active data sets into DRAM and SSD memory. The use of DRAM and SSD memory provides improvement over conventional type memory used by the file servers. For example, in contrast to conventional approaches, embodiments described herein enable cache appliances 212, 219 to (i) operate independently, (ii) operate in a manner that is self-contained, (iii) install in-line in the network path between the clients and file servers. Knowing the contents of each packet allows data exchanged with the file servers 220, 220a (e.g., NFS/CIFS data) to be prioritized optimally the first time the data is encountered by the cache appliances, rather than being moved after-the-fact.

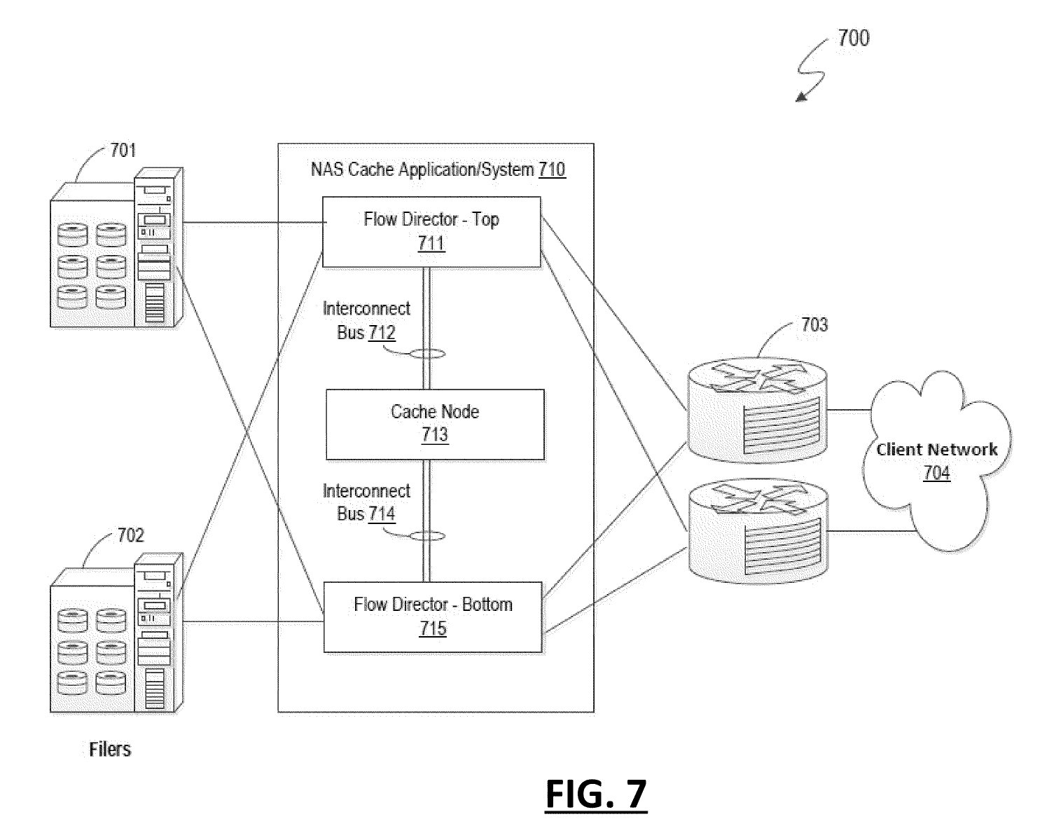

As described with some examples provided with FIG. 7 through FIG. 11, each of cache appliance 212, 219 includes detection monitors 225 that monitor and respond to system health events/changes at the caching system.

FIG. 3 illustrates an example of a cache system for use with a system such as described with FIG. 2. In particular, FIG. 3 illustrates a cache system 300 that includes multiple data servers 310 and flow directors 312. In this way, the cache system 300 can include multiple appliances, including NAS cache appliances. The cache system 300 utilizes network switches 305 to connect to clients 303 across one or more networks. In implementation, the components of the cache system 300 (e.g., data servers 310, flow directors 312) can be positioned in-line with respect to clients 303 and file system servers 320 of a networked system 301. Accordingly, connectivity between the clients 303 and the cache system 300, as well as between the cache system 300 and the file system servers 320 of the networked system 301, can be across one or more networks. The networked system 301 can correspond to, for example, a combination of file system servers of the networked system, as described with an example of FIG. 2 (e.g., see network system 200 of FIG. 2).

According to one aspect, the cache system 300 includes one or more data servers 310, one or more flow directors 312, and processing resources 330. In some implementations, the processing resources 330 that coincide with resources of the data servers 310 implement a cache operating system 332. Additionally, the processing resources 330 can perform various analytic operations, including recording and/or calculating metrics pertinent to traffic flow and analysis.

In some embodiments, the data server 310 implements operations for packet-inspection, as well as NFS/CIFS caching. Multiple data servers 310 can exist as part of the cache system 300, and connect to the file servers 320 of the networked system 301 through the flow director(s) 312. The flow director(s) 312 can be included as active and/or redundant devices to interconnect the cache system 300, so as to provide client and file server network connectivity for filer 301.

The cache operating system 332 can synchronize the operation of the data servers 310 and flow directors 312. In some embodiments, the cache operating system 332 uses active heartbeats to detect node failure (e.g., failure of one of the data servers 310). If a node failure is detected, the cache operating system 332 removes the node from the cache system 300, then instructs remaining nodes to rebalance and redistribute file responsibilities. If a failure is detected from one of the flow directors 312, then another redundant flow director 312 is identified and used for redirected traffic.

In one implementation, a user interface 336 can be implemented through the processing resources 330. The user interface 336 can be implemented as, for example, a web-interface. The processing resources 330 can be used to gather and view statistics, particularly as part of the operations of the data server 310 and the flow director 312. The user interface 336 can be used to display metrics and statistics for purpose of, for example, troubleshooting storage network issues, and configuring the NAS cache system 300. For example, administrators can use the user interface 336 to view real-time information on cache performance, policy effectiveness, and application, client, and file server performance.

According to some embodiments, the data servers 310 include packet inspection and NFS/CIFS caching infrastructure for the cache system 300. In one implementation, the data servers 310 utilize multiple cache media to provide different performance levels. For example, in some embodiments, each data server 310 supports DDR3 DRAM and high performance SSD storage for caching. In operation, data servers 310 communicate with both clients 303 and file system servers 320, by, for example, inspecting every message and providing the information necessary to intelligently cache application data.

In some embodiments, the data servers 310 can be implemented in a manner that is extensible, so as to enable expansion and replacement of data servers 310 from the cache system 300. For example, each data server 310 can employ hot swappable power supplies, redundant fans, ECC memory and enterprise-level Solid State Disks (SSD).

Further, in some embodiments, the flow directors 312 operate as an enterprise-level Ethernet switch (e.g., 10 GB Ethernet switch). The flow directors 312 can further be implemented with software so as to sit invisibly between clients 303 and file system servers 320. In the cache system 300, the flow director 312 load balances the data severs 310. The individual flow directors 312 can also provide the ingress and egress point to the network. Additionally, the flow directors 312 can also filter traffic that passes through non-accelerated protocols. In some implementations, flow directors 312 work in concert with the operating system 332 to provide failover functionality that ensures access to the cached data is not interrupted.

In some embodiments, the flow directors 312 can also operate so that they do not participate in switching protocols between client and file server reciprocal ports. This allows protocols like Spanning Tree (STP) or VLAN Trunking Protocol (VTP) to pass through without interference. Each flow director 312 can work with the data servers 310 in order to support, for example, the use of one or more of Link Aggregation (LAG) protocols, 802.1Q VLAN tagging, and jumbo frames. Among other facets, the flow directors 312 can be equipped with hot swappable power supplies and redundant fans. Each flow director 312 can also be configured to provide active heartbeats to the data servers 310. In the event that one of the flow directors 312 becomes unresponsive, an internal hardware watchdog component can disable client/file server ports in order to facilitate failover on connected devices. The downed flow director 312 can then be directed to reload and can rejoin the cache system 300 if once again healthy.

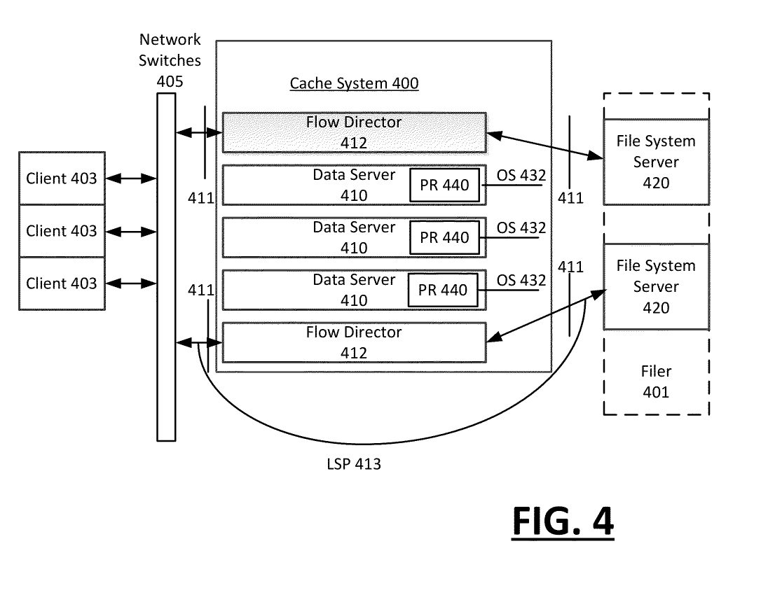

FIG. 4 illustrates another example of a cache system for use with a system such as described with FIG. 2. In particular, FIG. 4 illustrates a cache system 400 that includes multiple data servers 410, flow directors 412 and processing resources 430 on which an operating system 432 can be implemented. In this way, the cache system 300 can include multiple appliances, including NAS cache appliances. The cache system 400 utilizes network switches 405 to connect to clients 403 across one or more networks. In implementation, the cache system 400 can be positioned in-line with respect to clients 403 and file system servers 420 of a networked system 401. Accordingly, connectivity between the clients 403 and the cache system 400, as well as between the cache system 400 and the file system servers 420 of the networked system 401, can be across one or more networks. As with an example of FIG. 3, the networked system or filer 401 can correspond to, for example, a combination of file system servers 420 that provide one or more NAS filers, as described with an example of FIG. 2 (e.g., see system 200 of FIG. 2).

In an example of FIG. 4, the flow directors 412 and data server 410 support 802.1Q VLAN tagging connections 411 to the client-side switch and the file servers. The data servers 410 operate to maintain the connection state between the clients 403 and file servers 420 of the filer, so that network traffic can flow indiscriminately through either of the flow directors 412. In this way, the flow directors 412 are essentially equal bidirectional pathways to the same destination. As a result, any link failover is negotiated between the client switch and individual file servers, with the operating system 432 facilitating failover with Link State Propagation (LSP) communications 413 and link aggregation protocols. In this arrangement, the flow director(s) 412 provide an LSP feature for the in-line cache system 400 to maintain end-to-end link state between the client switch and file server. Since, in the example provided with FIG. 4, the flow director(s) 412 are physically located between these devices, these flow directors actively monitor reciprocal connections so both client-side and file server-side connections are in sync. This allows implementation of the LAG protocol (if employed) to dynamically adjust in case of link failure.

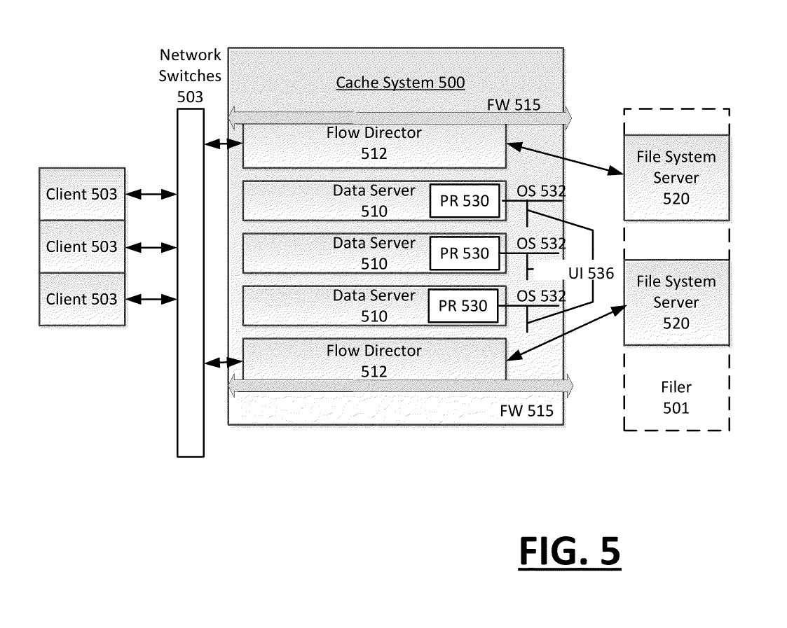

FIG. 5 illustrates another example of a cache cluster for use with a system such as described with FIG. 2. In an example of FIG. 5, an in-line NAS cache system 500 includes two (or more) flow directors 512, a supporting data server 510, and processing resources 530 on which an operating system 532 can be implemented. In this way, the cache system 500 can include multiple appliances, including NAS cache appliances. The cache system 500 utilizes network switches 505 to connect to clients 503 across one or more networks. In implementation, the cache system 500 can be positioned in-line with respect to clients 503 and file system servers 520 of a networked system 501. Accordingly, connectivity between the clients 503 and the cache system 500, as well as between the cache system 500 and the file system servers 520 of the networked system 501, can be across one or more networks. As with an example of FIG. 3, the networked system or filer 501 can correspond to, for example, a combination of file system servers 520 that provide one or more NAS filers, as described with an example of FIG. 2 (e.g., see system 200 of FIG. 2).

The data servers 510 can be connected between individual file system servers 520 and a client-side switch for some of the clients 503. As depicted, the flow directors 512 and data server 510 provide a fail-to-wire pass through connection 515. The connection 515 provides a protection feature for the in-line cache system 500 in the event that the data servers 510 fail to maintain heartbeat communications. With this feature, the flow director(s) 512 are configured to automatically bypass the data server(s) 510 of the cache system in case of system failure. When bypassing, the flow directors 512 send traffic directly to the file system servers 520. Using active heartbeats, the flow directors 512 can operate to be aware of node availability and redirect client requests to the file system server 520 when trouble is detected at the cache system.

A bypass mode can also be activated manually through, for example, a web-based user interface 536, which can be implemented by the processing resources 530 of the cache system 500. The active triggering of the bypass mode can be used to perform maintenance on data server nodes 510 without downtime. When the administrator is ready to reactivate the cache system 500, cached data is revalidated or flushed to start with a “clear cache” instruction.

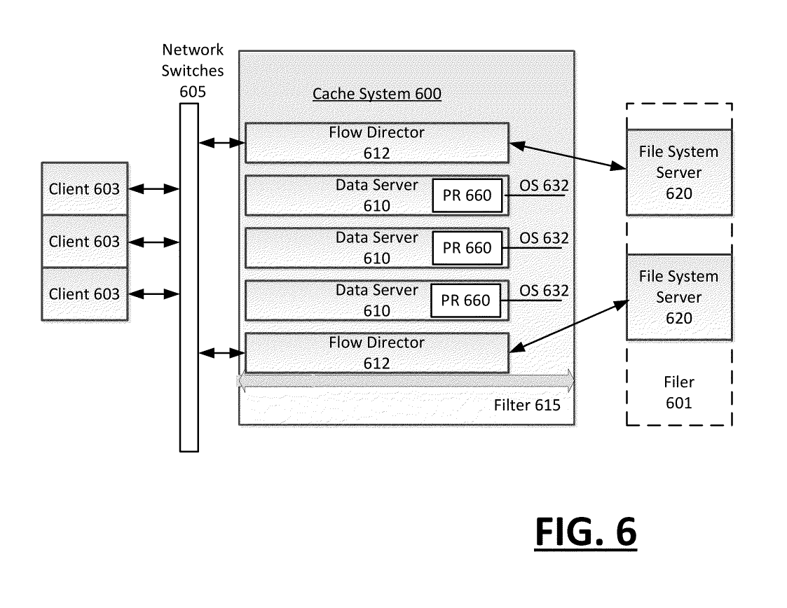

FIG. 6 illustrates another example of a cache system for use with a system such as described with FIG. 2. In an example of FIG. 6, an in-line cache system 600 includes two (or more) flow directors 612 and one or more supporting data servers 610. In this way, the cache system 600 can include multiple appliances, including NAS cache appliances. The cache system 600 utilizes network switches 605 to connect to clients 603 across one or more networks. The data server 610 can be connected between one of the file system servers 620 of the NAS filer 601 and clients 603 (including iSCSI clients). In implementation, the cache system 600 can be positioned in-line with respect to clients 603 and file system servers 620 of a networked system 601. Accordingly, connectivity between the clients 603 and the cache system 600, as well as between the cache system 600 and the file system servers 620 of the networked system 601, can be across one or more networks. As with an example of FIG. 3, the networked system or filer 601 can correspond to, for example, a combination of file system servers 620 that provide one or more NAS filers, as described with an example of FIG. 2 (e.g., see system 200 of FIG. 2).

As depicted, the flow directors 612 and data server 610 of the cache system 600 provide a low latency, wire-speed filtering feature 615 for the in-line cache system 600. With filtering feature 615, the flow director(s) 612 provide advanced, low-latency, wire-speed filtering such that the flow director filters only supported-protocol traffic to the system. Substantially all (e.g., 99%) other traffic is passed straight to the file system servers 620 of the NAS filer 601, thereby ensuring that the data servers 610 focus only on traffic that can be cached and accelerated.

In support of the various features and functions described herein, each cache system 600 implements operating system 632 (IQ OS) (e.g., FreeBSD) to be customized with a purpose built caching kernel. Operating across all data servers and interacting with flow directors in the cache system, the OS 632 serves basic functions that include network proxy, file object server, and generic storage access. As a network proxy between clients and file servers, the OS 632 performs Layer 2 topology discovery to establish what is physically connected. Once the topology is determined, it maintains the network state of all connections. As requests are intercepted, the requests are converted to NAS-vendor independent file operations, streamlining the process while allowing the cache system 600 to incorporate other network protocols in the future.

Once requests are converted, the cache appliance system 600 handles generic metadata operations, and data operations are mapped to virtual devices. Virtual devices can be implemented with DRAM, flash memory, and/or other media, and are categorized according to their performance metrics, including latency and bandwidth. Virtualization of devices allows the OS 632 to easily incorporate faster media to further improve performance or denser media to add cache capacity. Once the media hierarchy or tier is established within the cache resources of the system 600, blocks are promoted and demoted based on frequency of use, unless “pinned” to a specific tier by the administrator. Additionally, in some implementations, the data servers 610 can operate a policy engine, which can implement user-defined polices, and proactively monitor the tiers of cache and prioritize the eviction of data blocks.

In one implementation, the cache system 600 may include a DRAM virtual tier where metadata is stored for the fastest random I/O access. In the DRAM virtual tier, user-defined profiles can be “pinned” for guaranteed, consistent access to critical data. SWAP files, database files, and I/O intensive virtual machine files (VMDKs) are a few examples of when pinning data in DRAM can provide superior performance.

In addition or in the alternative, some implementations provide that each cache system 600 may include a virtual tier for Solid State Disks (SSD) which can be added at any time to expand cache capacity. To maximize performance and capacity, individual SSDs are treated as an independent virtual tier, without RAID employment. In the event of a failed SSD, the overall cache size will shrink only by the missing SSD. The previously cached data will be retrieved from the file server (as requested) and stored on available media per policy.

Using packet inspection functionality of the data server 610, the OS 632 at the cache system 600 learns the content of data streams, and at wire-speed, makes in-flight decisions based on default or user-defined policies to efficiently allocate high-performance resources where and when they are required most. Because data is initially stored to its assigned virtual tier, blocks are moved less frequently, which increases overall efficiency. However, as data demands change, the OS 632 also considers frequency of use to promote or demote blocks between tiers (or evict them completely out of cache).

In support of the caching operations, each cache system 600 can include one or more default built-in policies which assign all metadata to the highest tier (currently DRAM) and all other data to a secondary pool with equal weight. Frequency of use will dictate if data is to be migrated between tiers. And with no user-defined profiles enabled, the default policy controls caching operations. In addition, one or more file policies may be specified using filenames, file extensions, file size, file server, and file system ID (FSID) in any combination with optional exclusions. An example file policy would be to “cache all *.dbf files less that 2 GB from file server 192.168.2.88 and exclude file201.dbf.” Client policies may also use IP addresses or DNS names with optional exclusions to specify cache operations. An example client policy would be to “cache all clients in IP range: 192.168.2.0/24 and exclude 192.168.2.31”

As will be appreciated, one or more cache policy modifiers may be specified, such as a “quota” modifier which imposes a limit on the amount of cache a policy consumes and can be specified by size or percent of overall cache. Quota modifiers can be particularly useful in multitenant storage environments to prevent one group from over-consuming resources. In addition, a “schedule” modifier may be used to define when a policy is to be activated or disabled based on a time schedule. An example, the cache system 600 can activate the “Nightly Software Build” profile at 9 pm and disable at 6 am. Another policy modifier referenced above is a user-created exception to “pin” data to a particular tier or the entire cache. A pinned policy means other data cannot evict the pinned data—regardless of frequency of use. Such a policy can be useful for data that may not be accessed often, but is mission-critical when needed. In busy environments that do not support pinning, important but seldom used data will never be read from cache because soon after it is cached, the data is evicted before it is needed again. Pinned policies can address this unwanted turnover. Yet another modifier is a “Don't Cache” modifier which designates by file name of client request selected data that is not to be cached. This option can be useful when dealing with data that is only read once, not critical, or which may change often. As another example, a “priority” modifier may be used to manually dictate the relative importance of policies to ensure data is evicted in the proper order. This allows user-defined priorities to assign quality of service based on business needs.

Using the cache policies and modifiers, the cache behavior of the cache system 600 can be controlled to specify data eviction, migration, and multi-path support operations. For example, the cache system 600 can make an eviction decision based on cache priority from lowest to highest (no cache, default, low, high, and pin), starting with the lowest and moving to higher priority data only when the tier is full. In one implementation, eviction from cache resources of the cache system 600 can be based on priority, and then usage. For example, the lowest priority with the least accessed blocks will be evicted from cache first, and the highest priority, most used blocks will be evicted last.

The cache system 600 can also control the migration of data within the cache based strictly by usage, so that the most active data, without regard to priority, will migrate to the fastest cache tier. Likewise, as other data becomes more active, stale data will be demoted. Data pinned to a specified tier is excluded from migration.

In some implementations, the cache system 600 can also include a Mufti-Path Support (MPS) mechanism for validating the data in the cache resources of the cache system 600. With the MPS mechanism, the NAS cache checks backend file server attributes at a configurable, predefined interval (lease time). Data may change when snap-restoring, using multiprotocol volumes (i.e., CIFS, NFSv2/4), or if there are clients directly modifying data on the backend file server. When a client reads a file, MPS evaluates its cache lease time to determine whether it needs to check file server attributes. If not expired, the read will be served immediately from cache. If expired, MPS checks the backend file server to confirm no changes have occurred. If changes are found, MPS will pull the data from the file server, send it to the client, reset its lease, and update the cache. With regular activity, file leases should rarely expire since they are updated on most NFS operations. Expiration only occurs on idle files. MPS timeout can be configured from, for example, a minimum (e.g., 3 seconds) to a maximum (e.g., 24 hours).

FIG. 7 illustrates a NAS cache application or stem deployed on a networked system, according to one or more details. Among other benefits, an example such as described with FIG. 7 improves the speed with which a computer client can access data made available via, for example, a NAS system. The NAS cache application or system 710 may be deployed to provide access to the network 700 that hosts both the clients 704 and NAS File System (Filers) 701, 702. In some implementations, the NAS cache system 710 may be deployed transparently, in which case the NAS cache application system 710 does not assume an IP address on the network 700 and does not take any action that would indicate the presence of a cache. In this case, if network connections are proxied (to allow the connection to be cached), then the proxied connections use the true server and client IP addresses, maintaining the transparency of the cache deployment. In an example of FIG. 7, the NAS cache application or system 710 is connected between file servers 701, 702 and client network 704 via switch routers 703. The NAS cache application or system 710 is also configured with redundant flow director s 711, 715. The flow directors 711, 715 are connected to a shared cache node 713 over interconnect system busses 712, 713. Each of the flow directors 711, 715 and the cache node (e.g., data server appliance) can be implemented as appliances that are interconnected by the busses 7122, 714.

The NAS cache system 710 includes one or more flow director s 711, 715 that provide a high speed customer network interface, one or more cache node s 713 that provide high performance caching with storage media access, and one or more interconnect busses 712, 714 for connecting the flow director and data server appliances. Among other benefits, the NAS cache application or system 710 can support growing levels of scalability and performance. With each flow director 711, 715, a high speed customer network interface provides access to the customer network for the system, thereby facilitating visibility into NAS protocol traffic. As further shown by an example of FIG. 7, the flow director interface(s) can be deployed as high speed network switches in a redundant configuration for performance and resiliency. In addition, the high performance cache node 713 provides the NAS protocol analysis and caching, along with access to storage (DRAM, Block devices, Fibre Channel Interface) for storing and retrieving cache data. In selected embodiments, one or more independent cache node s 713 are connected to the redundant flow director s 711, 715 using one or more interconnect busses 712, 714, where each bus distributes NAS protocol traffic to/from data server appliance(s) 713. In addition, the interconnect busses 712, 714 provide a communication mechanism between the flow director appliances 711, 715 devices and the data server appliance(s) 713, as well as communication between multiple cache node appliance(s) 713.

In some implementations, a combination of these functions may be merged into a single appliance. In one example, a high performance Ethernet switch may be used to combine the functionality for both the high speed network interface(s) (e.g., flow directors 711, 715) and the internal interconnect bus (e.g., 712) into a single flow director appliance.

For overall reference, the flow directors 711, 715 can provide a number of functions for the NAS cache system 710. In addition to providing network access to both the cache node graphical user interface (GUI) and command line interface (CLI), the flow directors 711, 715 can also provide current status information for the flow director and cache node appliances using a web user interface, as well as providing configuration/status information using a command line interface. The flow directors 711, 715 can also allow all network traffic to flow freely between clients and filers in a “disengaged” mode, regardless of the presence or the state/health of cache node appliance 713. In other embodiments, the flow directors 711, 715 may direct “interesting” client-filer network traffic (e.g., NAS protocol) to the cache node appliance 713 for processing, leaving uninteresting traffic to flow directly between client and filers. In addition, the flow directors 711, 715 can automatically fail over to the “disengaged” mode when an “engaged” cache node 713 becomes unavailable.

In selected transparent NAS cache deployment embodiments, the flow directors 711, 715 are configured with non-standard switching behaviors. For example, instead of the standard terminate-and-respond behavior for LLDP and LACP packets, the flow director appliance may be configured so that it does not act as an endpoint for LLDP or LACP packets, but rather it allows them to pass between clients and filers. Also, instead of the standard behavior of not associating link state changes between client facing and filer facing switch ports, the flow directors 711, 713 can be configured to propagate changes in link states between clients and filers with the Link State Propagation feature.

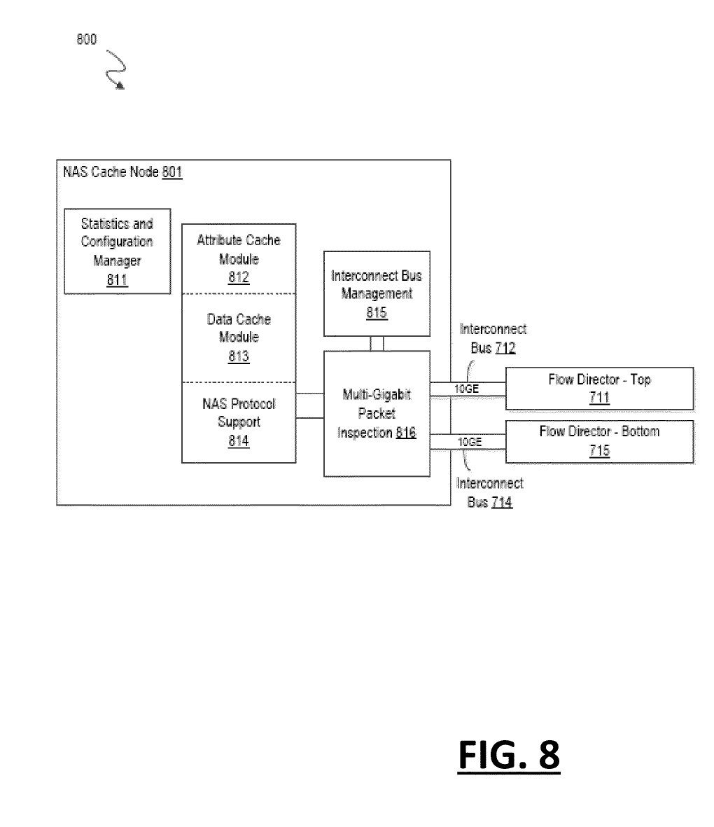

FIG. 8 illustrates an example of the functional operation of a NAS cache node appliance 801 connected between redundant flow director appliances 711, 715. The NAS cache node appliance 801 can correspond to the cache node 713 of the NAS cache system 710, as described with an example of FIG. 7. As depicted, the NAS cache node appliance 801 and redundant flow directors 711, 715 are deployed at a location in the network where to monitor, and interact with, traffic which intends to access files on a NAS filers. To support caching operations, the NAS cache node appliance 801 uses an interconnect bus manager 815 to manage the interconnect busses 712, 714 which connect the cache node and flow director appliances, and to respond to system health events/changes at the NAS cache application/system 710 as shown in FIG. 7. When a request to read or write application data is received from a remote storage client, the NAS cache node appliance 801 uses dedicated, high-speed packet inspection hardware 816 to inspect the packets of incoming requests to determine if they should be passed inward for further processing by the NAS cache node appliance 801 or forwarded to another destination, such as the destined NAS filer. For example, if remote NAS client requests application data that is stored on the NAS cache node appliance 801, the packet inspection hardware 816 may process the request based on I/O profiles to determine if the request is to be processed by the NAS cache node appliance 801. If so, the request is passed internally to the tiered memory cache system. For example, in one implementation, the NAS cache node appliance 801 includes tier 1 storage, which can be reserved for the most critical data (including email, high transaction databases, business critical processes and line of business applications), while tier 0 storage refers to an in-band, network-resident, policy-driven, high-performance, scalable tier of memory subsystems that is used for the storage of business critical data under control of a policy engine that is managed independently from the one or more NAS filers. Within the tiered memory of the NAS cache node appliance 801, a volatile or dynamic random access memory virtual tier may be used to store metadata and/or application data for the fastest random I/O access, while a non-volatile random access memory (NVRAM) or Solid State Storage (SSD) provides a space for caching pending write operations to NAS filers for the purpose of maintaining data coherency in a failure event, such as network packets not arriving to their destination. If it is determined that the request cannot be serviced by the NAS cache node appliance 801, the client request is sent to the destination NAS filer.

As will be appreciated, the physical design/implementation of each interconnect bus 712, 714 can be accomplished in many ways. For example, each interconnect bus 712, 714 may be implemented using two or more high speed (e.g., 10 GbE) connections acting in a Link Aggregate Group (LAG), which provide higher throughput and better fault tolerance for a lost link than a single, physical connection is capable of providing.

Address Configuration

With the interconnect busses 712, 714 being used to connect the flow directors 711, 715 and cache node appliances 713, each appliance may have their own responsibilities for address configuration and monitoring the shared interconnect bus 712, 714.

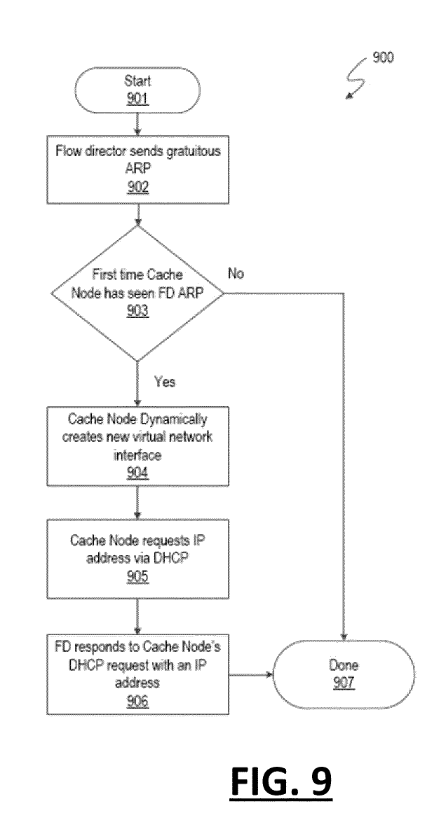

FIG. 9 illustrates an example process flow sequence 900 for a dynamic configuration process between the flow director and cache node appliances over interconnect system bus. In describing an example of FIG. 9, reference is made to FIG. 7 and FIG. 8 for purpose of illustrating suitable components for performing a step or sub-step being described. In an embodiment, a NAS cache system is positioned between the storage clients and the NAS filers (step 901). The flow director(s) 711, 715 generate a periodic, gratuitous Address Resolution Protocol (ARP) messages on the interconnect bus for each connected cache node appliance 801. Each cache node appliance 801 detects the gratuitous ARP message(s) (step 903). If the detected gratuitous ARP from this flow director appliance has been previously detected by the cache node appliance (negative outcome to step 903), the process ends. However, if the ARP message is the first one detected from this flow director appliance (affirmative outcome to step 903), the cache node appliance is triggered to dynamically create a virtual network interface for communicating with the flow director appliance, assuming one does not already exist (step 904). The cache node appliance 801 requests an IP address via DHCP on the interconnect bus, and the flow directors (711, 715) responds to the DHCP request with a valid IP address (step 906). At this point, the address configuration sequence is done (step 907).

Monitoring

In operation, the interconnect bus manager is responsible for monitoring the nodes deployed in each NAS cache system to ensure that the interconnect bus manager always provides a working network path between clients and filers on the network, and to always maintain cache coherency in a redundant flow director deployment so that all clients maintain data on the filers and cache in a consistent fashion.

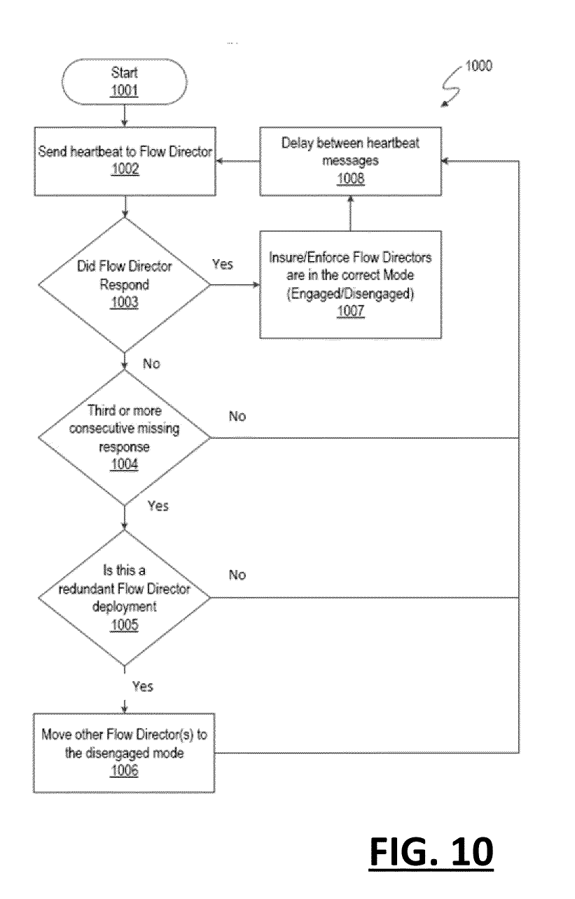

FIG. 10 depicts an example process flow sequence 1000 for a heartbeat-and-failover state machine implemented by a cache node appliance to maintain cache coherency and maintain communication over the network between the clients and file servers. A NAS cache system is positioned between the storage clients and the NAS filers (Step 1001). The cache node appliance 801 periodically sends heartbeat messages over the interconnect bus 712, 714 to each flow director appliance 711, 715 at regular intervals. Upon detecting a response to the heartbeat messages (affirmative outcome to detection step 1003), the cache node appliance insures that the flow director appliance(s) 711, 715 are in the correct mode (either engaged or disengage) (step 1007). However, if the cache node appliance 801 does not detect heartbeat responses (negative outcome to detection step 1003), the cache node appliance next detects (step 1004) if a specified number of heartbeat responses have not been received from the flow director appliance over a predetermined time period (e.g., 3 consecutive missed heartbeat responses). If the required number of missing responses is not met (negative outcome to detection step 1004), the process returns to step 1002. But if the threshold number of missing heartbeat responses is met (affirmative outcome to detection step 1004), the cache node appliance 801 determines if a redundant flow director deployment is present (step 1005). If not (negative outcome to detection step 1005), the process returns to step 1002. However, if it is a redundant flow director deployment is present (affirmative outcome to detection step 1005), this indicates that the cache node appliance 801 has detected no heartbeat responses from a flow director appliance 711, 715, so cache node appliance 801 instructs any other flow director appliance(s) to move the associated client-filer traffic associate with that cache node appliance into the disengaged mode (step 1006).

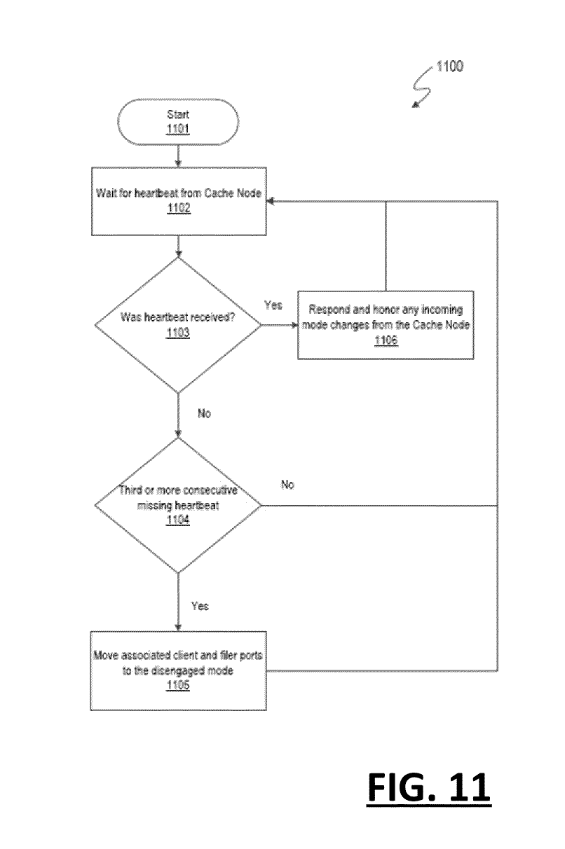

FIG. 11 which depicts an example process flow sequence 1100 for a heartbeat-and-failover state machine implemented by a flow director appliance to maintain cache coherency and maintain communication over the network between the clients and file servers, according to embodiments. A NAS cache system is positioned between the storage clients and the NAS filers (step 1101). The flow director appliance listens for a heartbeat message from the cache node appliance (step 1102). Upon detecting a heartbeat message (affirmative outcome to detection step 1103), the flow director appliance sends a heartbeat response and honors any incoming mode changes from the cache node appliance (step 1106). However, if the flow director appliance does not detect a heartbeat message (negative outcome to detection step 1103) and if a threshold number of missing heartbeats is met (affirmative outcome to detection step 1104) (i.e., 3 consecutive missed heartbeat messages), the flow director appliance 801 moves the associated client and filer traffic associated with that cache node appliance into the disengaged mode (step 1105).

Embodiments such as described provide that clients and filers on the network maintain their ability to communicate with one another in the event of a failure with the cache node appliance 801 (or loss of interconnect bus connectivity between a cache node appliance and flow director appliance). Additionally, cache coherency is preserved with deployment of redundant flow directors 711, 715. Specifically, embodiments as described provide that either both flow director appliances 711, 715 send NAS protocol traffic to the cache node appliance(s) (engaged mode) or that neither flow director appliance is sending NAS protocol traffic to the cache node appliance(s) (disengaged mode).

As will be appreciated, redundant flow director deployments may be used to address a number of failure scenarios at the NAS cache system.

In one failure scenario involving that of a cache node appliance 801 (such as loss of power, hardware failure, or software bug), both flow director appliances 711, 715 can detect 3 missed heartbeat messages from the cache node appliance and move the associated client and filer traffic into the disengaged mode, thereby maintaining communication over the network between the clients and filers.

In another failure scenario where the flow director appliance fails (such as loss of power, hardware failure, or software bug), the cache node appliance 801 detect 3 missed heartbeat message responses from the disconnected flow director appliance, and instruct the still-connected flow director appliance to move the associated client and filer traffic into the disengaged mode, thereby maintaining communication over the network between the clients and filers. In addition, cache coherency is maintained since, even though the cache node appliance does not know if the flow director appliance itself has failed or the connection to the flow director appliance has failed, the instruction to the still-connected flow director appliance to disengage the associated client and filer traffic will guarantee all client connections are going to the filer.

Another failure scenario can arise when there is a connection failure between the cache node appliance 801 and one of the flow director appliances 711, 713 (such as unplugging of interconnect bus). In this case, the disconnected flow director appliance will detect 3 missed heartbeat messages from the node and move the associated client and filer traffic into the disengaged mode. In addition, the cache node appliance 801 detect 3 missed heartbeat message responses from the disconnected flow director appliance (e.g., 711) and instruct the still-connected flow director appliance (e.g., 715) to move the associated client and filer traffic into the disengaged mode, thereby maintaining communication over the network between the clients and filers. In addition, cache coherency is maintained since, even though the cache node appliance 801 does not know if the flow director appliance 711, 715 has failed, or if the connection to the flow director appliance has failed. In either case, the instruction to the still-connected flow director appliance 711, 715 to disengage the associated client and filer traffic will maintain all client connections destined for the filer.

Another failure scenario arises when there is a connection failure between the cache node appliance 801 and both flow director appliances 711, 713 (such as unplugging of all Interconnect Bus connections). In this case, the disconnected flow director appliances 711, 713 both detect 3 missed heartbeat messages from the node and move the associated client and filer traffic into the disengaged mode, thereby maintaining communication over the network between the clients and filers.

While a variety of different architectures may be used to implement a cache appliance, an example alternative hardware implementation which can be used includes a network switch interconnect component for routing network traffic, a processor component for packet processing, a cache controller, and cache memory component for storing cached data files. The high-speed network switch provides client and filer interfaces and multiple 10 Gbps connections to the packet processing and cache controller hardware, manages data flow between the client/filer I/O ports and the packet processing and cache controller hardware, and may be optimized for network traffic where it is desirable to obtain low latency. In addition, one or more processor units are included to run the core software on the device to perform node management, packet processing, cache management, and client/filer communications. A substantial cache memory can be provided for storing data files, along with a cache controller that is responsible for connecting cache memory to the high-speed network switch.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for managing a system of appliances that are attached to a networked file system, the method being implemented by one or more processors and comprising:
connecting the system of appliances to the networked file system, so that the system of appliances intercepts traffic as between a plurality of clients and the networked file system;
wherein connecting the system of appliances includes implementing (i) a first resource appliance, and (ii) multiple flow directors that operate in an engaged mode and in a disengaged mode, each flow director operating in the engaged mode in order to direct traffic to the first resource, and in the disengaged mode, to pass traffic from the plurality of clients to the networked file system and from the networked file system to the plurality of clients;
determining when one of the multiple flow directors is inaccessible to a node within the system of appliances; and
in response to determining when one of the multiple flow directors is inaccessible to the node, sending a command to switch each of the other multiple flow directors into the disengaged mode.

2. The method of claim 1, wherein the first resource appliance is a cache appliance, and wherein the method further comprises connecting the system of appliances to the networked file system in order to cache a segment of the networked file system.

3. The method of claim 1, further comprising performing proxying operations on behalf of at least one of the plurality of clients or the networked file system when the multiple flow directors are operated in the engaged mode.

4. The method of claim 3, wherein connecting the system of appliances to the networked file system is performed transparently to the plurality of clients that actively exchange traffic with the networked file system.

5. The method of claim 1, wherein determining when one of the multiple flow directors is inaccessible includes repeatedly signaling one or more heartbeat signals to each of the multiple flow directors.

6. The method of claim 5, wherein determining when one of the multiple flow directors is inaccessible includes detecting no response to multiple heartbeat signals sent to one of the multiple flow directors.

7. The method of claim 1, wherein the clients and the networked file system exchange traffic using a Network File System protocol.

8. The method of claim 1, wherein determining when one of the multiple flow directors is inaccessible is performed by the first resource appliance.

9. A cache system comprising:
one or more data servers including a cache resource;
multiple flow directors, each flow director being operable in an engaged mode and in a disengaged mode, wherein each flow director operates in the engaged mode to direct traffic to at least one or more data servers, and in the disengaged mode, to pass traffic from the plurality of clients to the networked file system and from the networked file system to the plurality of clients;
wherein at least one of the data servers operates to determine when one of the multiple flow directors is inaccessible, and in response to determining when one of the multiple flow directors is inaccessible, send a command to switch each of the other multiple flow directors into the disengaged mode.

10. The cache system of claim 9, wherein the at least one data server determines when one of the multiple flow directors is inaccessible by repeatedly signaling one or more heartbeat signals to each of the multiple flow directors.

11. The cache system of claim 10, wherein the at least one data server determines when one of the multiple flow directors is inaccessible by detecting no response to multiple heartbeat signals sent to one of the multiple flow directors.

12. The cache system of claim 9, wherein the clients and the networked file system exchange traffic using a Network File System protocol.

13. The cache system of claim 9, wherein the one or more data servers and where the multiple flow directors combine to proxy operations on behalf of at least one of the plurality of clients or the networked file system when the multiple flow directors are operated in the engaged mode.

14. The cache system of claim 9, wherein the multiple flow directors and the one or more data servers are interconnected by one or more busses, to be external to networked file system.

15. A computer-readable medium for managing a system of appliances that are attached to a networked file system, the computer-readable medium including instructions, that when executed by one or more processors, cause the one or more processors to perform operations that include:
connecting the system of appliances to the networked file system, so that the system of appliances intercepts traffic as between a plurality of clients and the networked file system;
wherein connecting the system of appliances includes implementing (i) a first resource appliance, and (ii) multiple flow directors that operate in an engaged mode and in a disengaged mode, each flow director operating in the engaged mode in order to direct traffic to the first resource, and in the disengaged mode, to pass traffic from the plurality of clients to the networked file system and from the networked file system to the plurality of clients;
determining when one of the multiple flow directors is inaccessible from a node within the set of appliances; and
in response to determining when one of the multiple flow directors is inaccessible to the node, sending a command to switch each of the other multiple flow directors into the disengaged mode.

16. The computer-readable medium of claim 15, wherein the first resource appliance is a cache appliance, and wherein the computer-readable medium further comprises instructions for connecting the system of appliances to the networked file system in order to cache a segment of the networked file system.

17. The computer-readable medium of claim 15, further comprising instructions for performing proxying operations on behalf of at least one of the plurality of clients or the networked file system when the multiple flow directors are operated in the engaged mode.

18. The computer-readable medium of claim 17, wherein instructions for connecting the system of appliances to the networked file system includes instructions for transparently connecting the system of appliances to the networked file system.

19. The computer-readable medium of claim 15, wherein instructions for determining when one of the multiple flow directors is inaccessible includes instructions for repeatedly signaling one or more heartbeat signals to each of the multiple flow directors.

20. The computer-readable medium of claim 19, wherein instructions for determining when one of the multiple flow directors is inaccessible includes instructions for detecting no response to multiple heartbeat signals sent to one of the multiple flow directors.

21. The computer-readable medium of claim 15, wherein the plurality of clients and the networked file system exchange traffic using a Network File System protocol.

22. A cache system comprising:
one or more data servers including a cache resource;
multiple flow directors, each flow director being operable in an engaged mode and in a disengaged mode, wherein each flow director operates in the engaged mode to direct traffic to at least one or more data servers, and in the disengaged mode, to pass traffic from the plurality of clients to the networked file system and from the networked file system to the plurality of clients;
wherein at least one of the multiple flow directors operates to determine when that flow director is inaccessible to at least one of the one or more data servers, and in response to determining that it is inaccessible to at least one of the one or more data servers, switches into the disengaged mode.
